(19) United States
(12) Patent Application Publication
(10) Pub. No.: US 2015/0208680 A1
(43) Pub. Date: Jul. 30, 2015

(54) MILK POWDERS WITH A HIGH WHEY PROTEIN INDEX II

(71) Applicant: DMK Deutsches Milchkontor GmbH, Zeven (DE)

(72) Inventor: Sven-Rainer Döring, Zeven (DE)

(73) Assignee: DMK Deutsches Milchkontor GmbH, Zeven (DE)

(21) Appl. No.: 14/163,356

(22) Filed: Jan. 24, 2014

(51) Int. Cl. A23C 3/03; A23C 9/18

(52) U.S. Cl. CPC A23C 3/03; A23C 9/18

(57) ABSTRACT

A process for the production of low-bacteria milk powders having a whey protein nitrogen index (WPNI) of at least 2 is suggested, wherein
(a) solids are removed from raw milk in a process known in itself, then the cream is separated,
(b) the skim milk such obtained is subjected to heat infusion,
(c) the heated milk is concentrated to a dry matter of from 30 to 50% by weight,
(d) where required, the concentrate such obtained is subjected to thermal treatment for a period of at least 15 seconds at a temperature of at least 72° C., and
(e) the thermally treated product such obtained is processed to a dry powder by so spraying at 100 to 120° C.

### FIELD OF THE INVENTION

The invention generally relates to the field of dairy products and specifically relates to a new method of production of low-bacteria milk powders with a high whey protein nitrogen index (WPNI).

### PRIOR ART

To produce low-bacteria milk powders, for example, already pasteurized skim milk with a dry matter of about 9% is evaporated to a concentration of about 40%. However, the concentrates still contain a large quantity of thermo-resistant bacteria and spores, which particularly originate from the maize silage fed to the cows, and which end up in the raw milk as a result of insufficient cowshed hygiene. For this reason it has been necessary to subject the concentrates to high-heat treatment before spraying, by means of which the bacteria and spores are quantitatively destroyed, yielding a bacteria-free product of high quality.

However, high-heat treatment does not only affect the bacteria and spores; also the valuable whey proteins are completely, or to a very large part, denatured, which adversely changes the product in its functionality and nutrition physiology. Whey proteins belong to the albumins and globulins; those particularly include alpha-lactalbumin and beta-lactoglobulin, serum albumin, proteose peptone and the immunoglobulins. From a nutrition-physiological perspective whey proteins are high-value milk constituents, which, for example, in protein supplements are specifically used to build muscle. While untreated skim milk indicates a so-called whey protein nitrogen index (WPNI) as a parameter for its whey protein contents of above 6, specifically of 6.1, this value falls below 1 during conventional ultra-high heat treatment which is extremely undesired.

An alternative therefor might be to perform the thermal treatment at lower temperatures, for example, at about 70° C. instead of above 100° C. In fact, the products such obtained indicate a WPNI of above 5, however, the bacterial contamination is so high that products are obtained which are, at best, difficult to market.

It was, therefore, the object of the present invention to provide milk powders, namely, both skim milk powders and whole milk powders, which are either bacteria-free or low-bacteria as obtained only after high-heat treatment to this date—and which indicate a high WPNI of at least 2, particularly, at least 4 and specifically from 5.5 to 6, as obtained using low-heat methods, although these two parameters have always run in opposite directions. In addition, it was intended that this process is to be performed with a low technical effort.

### DESCRIPTION OF THE INVENTION

The subject-matter of the invention is a process for the production of low-bacteria milk powders with a whey protein nitrogen index (WPNI) of at least 2, particularly, at least 4, and specifically 5 to 7, wherein
(a) solids are removed from raw milk in a method known in itself, the cream is separated,
(b) the skim milk such obtained is subjected to heat infusion,
(c) the heated milk is concentrated to a dry matter of from 30 to 50% by weight,
(d) the concentrate such obtained is, where required, subjected to thermal treatment for a period of at least 15 seconds at a temperature of at least 72° C. and
(e) the thermally treated product such obtained is processed to a dry powder by spraying at a temperature of from 100 to 120° C.

Surprisingly it was found that the separation of the bacteria from the milk can be achieved quantitatively by heat infusion at a temperature of about 135° C. without that the whey proteins are denatured thus not requiring ultra-high heat treatment any more.

### BRIEF DESCRIPTION OF THE DRAWINGS

The present invention will be described in greater detail with reference to the accompanying drawings in which

FIG. 1 is a schematic flow chart illustrating production of low-bacteria milk powders according to the prior art, and

FIG. 2 is a schematic flow chart illustrating production of low-bacteria milk powders according to the present invention.

### DESCRIPTION OF THE PREFERRED EMBODIMENTS

To heat up the milk concentrate to a temperature at which it can be sprayed, temperatures of about 70° C.—where whey proteins are also not denaturing yet—are sufficient. Technically it is quite simple to carry out this process, and it supplies the desired low-bacteria product with a high WPNI. The following Table A summarizes the typical specification requirements for a low-bacteria milk powder and the results obtained using the process according to the invention:

TABLE A
Specification of a low-bacteria powder

| | | Require- | |
|---|---|---|---|
| Type of bacteria | Method | ment | Invention |
| Mesophile spores | 10 min 80° C./ | max. 500/g | 2000/g |
| | 30° C. | | |
| Thermophile spores | a) 10 min 80° C./ | max. 500/g | 3000/g |
| | 55° C. | | |
| | b) 30 min 100° C./ | | |
| | 55° C. | | |
| Bacillus Cereus | 10 min 80° C./ | <10/g | <100/g |
| | 30° C. selective | | |
| | medium | | |
| Thermophile | 55° C. | max. 500/g | 4000/g |
| bacteria | | | |
| Sulfite-reducing | 10 min 80° C./ | max. 10/g | <10/g |
| spores | 37° C. (MPN | | |
| | selective broth) | | |
| Clostridium | 10 min/80° C. | max. 10/g | <10/g |
| perfringens | | bis neg/g | |
| Salmonella | LFGB § 64 modf. | neg in 750- | neg in 750- |
| | | 1500 g | 1500 g |
| Enterobacter sakazakii | Selective medium | neg in 375- | neg in |
| | | 750 g | 375 g |

Pasteurization

The primary thermal treatment of the raw milk performed in step (a) is preferably performed in heat exchangers, whereby specifically plate heat exchangers have proved to be particularly suitable. There is a temperature gradient at the heat exchangers, which, however, is selected such that the raw milk is heated to a temperature of from about 70 to 80° C. and, more particularly, from about 72 to 74° C. for a residence time of a minimum of 20 and a maximum of 60 seconds, preferably, about 30 seconds.

The separation of solid non-milk particles and the skimming of a fat content of about 4% by weight is usually carried out in a downstream component, preferably, a separator. Said components are adequately known from the state of the art. Separators by the company GEA Westfalia Separator GmbH, which allow the joint or single use of both steps (http://www.westfalia-separator.com/de/anwendungen/mnolkereitechnik/milch-molke.html), are widely used in the dairy industry. Corresponding components have been disclosed, for example, in DE 10036085 C1 (Westfalia), and are perfectly known to one skilled in the art. Thus no explanations are needed on how to carry out these process steps, as they are understood to be part of the general specialist knowledge.

Heat Infusion

In the process of heat infusion, the product to be treated and superheated steam are alternately sprayed via concentric ring nozzles in a reaction space. Essentially, the idea of this measure is to achieve a good mixing of the droplets thus ensuring an optimum heat transfer as well as avoiding—by means of the steam pressure gradient which adjusts from the outside to the inside of the space—that the product is deposited on the hot walls of the infusion tank where it will disintegrate. Heat infusion usually requires a residual time from 0.1 to 5 seconds, whereby temperatures may be from about 120 to about 150° C., preferably, about 135° C. The product phase deposits on the bottom of the reactor where it may be collected and further processed. This technology and the corresponding components have been described in detail in international patent applications WO 2010 086082 A1 and WO 2011 101077 A1 (GEA). The present application refers to their teaching in said scope.

Thermal Treatment and Drying

The milk treated by heat infusion is subsequently concentrated, for example, by means of evaporators or by conventional membrane methods (for example, reverse osmosis), or by a combination of both methods.

In a further embodiment of the present invention, in the scope of which whole milk powders are to be obtained, the cream separated in step (a) is added to the heated milk again. It is crucial that the skim milk—and not the whole milk—is subjected to heat infusion. If one would refrain from separating the cream, the high fat load would, depending on the circumstances, lead to an incomplete killing of the bacteria due to the high heat load. As also the cream may still contain bacteria, it is subjected to thermal treatment for a period of between 1 and 10, preferably, between 3 and 5 seconds at temperatures of from 85 to 138 ° C. before combining it with the skim milk. The high temperatures are not significant at this point, as the cream contains lipids to a predominant extent and no thermally sensitive proteins.

After thermal treatment, the heated concentrate is processed to a dry powder. Suitable methods are belt drying, freeze drying and, especially, spray-drying at temperatures within the range of from 100 to 120° C.

The powders usually contain a residual moisture of 1 to 5, preferably, 2 to 3% by weight, in which the fat is more or less evenly distributed in the fat-free dry substances, i.e., proteins, sugars and salts in the form of enclosures. Before spraying, also other additives may be added to the homogenized concentrates, such as, for example, lecithins or food emulsifiers [EP 1314367 A1, Nestle].

### INDUSTRIAL APPLICATION

Two further forms of embodiment of the present invention relate, on the one hand, to low-bacteria low-heat skim milk powders and to low-bacteria low-heat whole milk powders, which each have a whey protein nitrogen index of above 2, preferably in the range from 3 to 7.5 and, particularly, in the range from 5 to 7, on the other.

The skim milk powders are obtained by
(a) removing solids from the raw milk using known methods, separating the cream,
(b) subjecting the skim milk such obtained to heat infusion,
(c) pasteurizing the heated milk such obtained,
(c) concentrating the pasteurized milk such obtained to a dry matter of from 30 to 50% by weight,
(d) where required, subjecting the concentrate such obtained to thermal treatment for a period of at least 15, preferably, 15 to 20 seconds at a temperature of at least 72, preferably, 72 bis 80° C., and
(e) processing the thermally treated product such obtained to a dry powder.

The whole milk powders are obtained the same way, it is merely that the cream separated in step (a) is—as explained above—firstly subjected to high-heat treatment before adding it to the product obtained in the heat infusion process. In this case, the preferred WPNI is between 5 and 6.5.

### EXAMPLES

### Comparison Example V1

Solids were removed from raw milk in a method known in itself, then the milk was pasteurized and skimmed such that a skim milk with a dry matter of about 9% by weight was obtained. Said skim milk was gently evaporated, yielding a dry matter of ca. 40% by weight. The concentrate such obtained had a WPNI of 6.1 and was subjected to high-heat treatment at 120° C. for a period of about 5 seconds, thus destroying spores and any other bacteria. A bacteria-free concentrate was obtained, which was then sprayed using a spray tower. A practically bacteria-free high-heat skim milk powder with a WPNI of only 1.3 was obtained.

### Comparison Example V2

Example V1 was repeated; instead of a high-heat treatment at 105° C., however, thermal treatment was carried out at 70° C. for 5 seconds as well. After spraying, a low-heat skim milk powder with a WPNI of 5.9 was obtained, which, however, was contaminated by bacteria and thus only suitable for consumption to a limited degree.

### Example 1

### Production of a Low-Bacteria Skim Milk Powder

Example V2 was repeated, however, the skim milk was subjected—before the evaporation step—to heat infusion at 135° C. for 3 seconds, the product such treated was evaporated and thermally treated as described above, and sprayed. A low heat skim milk powder with a WPNI of 6.8 was obtained, which was practically bacteria-free.

### Example 2

### Production of a Low-Bacteria Whole Milk Powder

Solids were removed from raw milk using a method known in itself, the milk was pasteurized and skimmed such that a skim milk with a dry matter of ca. 9% by weight was obtained. It was subjected to heat infusion as described in Example 1. The cream obtained in the skimming process was subjected to high-heat treatment at 125° C. and again added to the skim milk such that a whole milk was obtained. A low heat whole milk with a WPNI of 6.3 was obtained, which was practically bacteria-free.

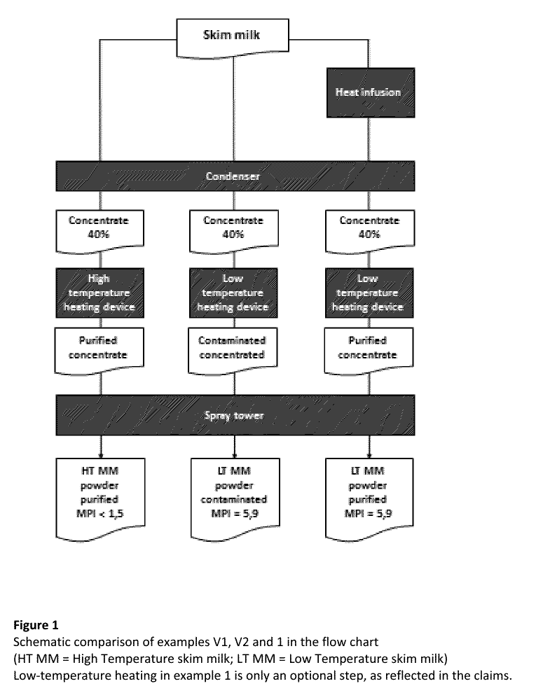

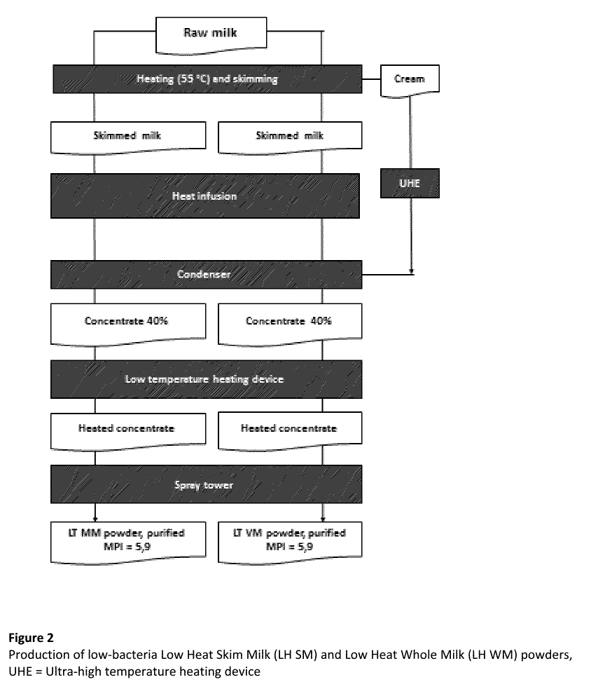

Examples V1, V2 and 1 are juxtapositioned to a flow diagram in FIG. 1. FIG. 2 represents the differences in the production of skim milk and whole milk powders.

1. A process for the production of low-bacteria milk powders having a whey protein nitrogen index (WPNI) of at least 2, wherein
(a) solids are removed from raw milk in a method known in itself, followed by a separation of the cream,
(b) the skim milk such obtained is subjected to heat infusion,
(c) the heated milk is concentrated to a dry matter of 30 to 50% by weight,
(d) where required, the concentrate such obtained is subjected to thermal treatment for a period of at least 15 seconds at a temperature of at least 72° C., and
(e) the thermally treated product such obtained is processed to obtain a dry powder by spraying at a temperature of from 100 to 120° C.

2. The process of claim 1, wherein heat infusion is performed at a temperature of from 120 to 150° C.

3. The process of claim 1, wherein heat infusion is performed for a period of from 0.1 to 5 seconds.

4. The process of claim 1, wherein the cream separated in step (a) is subjected to ultrahigh heat treatment and added to the skim milk again before heat treatment.

5. The process of claim 1, wherein the cream is subjected to a thermal treatment for a period of from 1 to 10 seconds at a temperature of from 85 to 145° C.

6. The process of claim 1, wherein the concentrate is processed to a dry powder by spraying.

7. A low-bacteria low-heat skim milk powder, obtainable according to the process according to claim 1.

8. The skim milk powder of claim 7, wherein the WPNI in the range of from 3 to 7.5.

9. The skim milk powder of claim 7, wherein the WPNI in the range of from 5 to 7.

10. A low-bacteria low-heat whole milk powder, obtainable according to the process of claim 1.

11. The whole milk powder of claim 10, wherein the WPNI in the range of from 3 to 7.5.

12. The whole milk powder of claim 10, wherein the WPNI in the range of from 5 to 6.5.
